(19) United States
(12) Patent Application Publication
(10) Pub. No.: US 2026/0328352 A1
(43) Pub. Date: Oct. 22, 2026

(54) ELECTRONIC FIREPLACE UNIT

(71) Applicant: Irvine Home Company, Inc., Orange, CA (US)

(72) Inventors: Yue Zhang, Irvine, CA (US); Hol Yang Nathanael Leung, Vancouver (CA); Inderjit Kanwal, New Westminster (CA)

(73) Assignee: Irvine Home Company, Inc., Orange, CA (US)

(21) Appl. No.: 19/650,194

(22) Filed: Apr. 16, 2026

Related U.S. Application Data
(60) Provisional application No. 63/790,613, filed on Apr. 17, 2025.

(51) Int. Cl. F21S 10/04; F24H 3/02

(52) U.S. Cl. CPC F21S 10/04; F24H 3/022

(57) ABSTRACT

Aspects of the disclosure are directed to electronic fireplace units. In accordance with one aspect, the disclosure includes a housing including a blower vent, a floor panel and an electrical housing area; at least one visual display panel within the housing, the first visual display panel configured to display a static image, a dynamic image or a video; a heating unit configured to provide a heating source for the fireplace unit; and a power supply coupled to the heating unit and the at least one visual display panel, the power supply configured to supply electrical energy to the heating unit and the at least one visual display panel.

### CLAIM OF PRIORITY UNDER 35 U.S.C. § 119

The present Application for Patent claims priority to Provisional Application No. 63/790,613 entitled “ELECTRONIC FIREPLACE UNIT” filed on Apr. 17, 2025, and assigned to the assignee hereof and hereby expressly incorporated by reference herein.

### TECHNICAL FIELD

The technology discussed below relates generally to fireplace units, and more particularly, to electronic fireplace units.

### BACKGROUND

Heating units such as fireplace units are used in buildings, residential dwellings and outdoor recreation areas to provide heat for warmth. Traditional fireplaces include using wood or coal as energy sources in which the wood or coal is burned to provide heat. In another type of fireplace, electricity (e.g., with electric coils) are used to generate heat. Some of these fireplaces that use electricity as the heat generating source may include a display of visual image of flames to make it appear as a traditional wood/coal burning fireplace.

### BRIEF SUMMARY OF SOME EXAMPLES

The following presents a summary of one or more aspects of the present disclosure, in order to provide a basic understanding of such aspects. This summary is not an extensive overview of all contemplated features of the disclosure, and is intended neither to identify key or critical elements of all aspects of the disclosure nor to delineate the scope of any or all aspects of the disclosure. Its sole purpose is to present some concepts of one or more aspects of the disclosure in a form as a prelude to the more detailed description that is presented later.

In one aspect, the disclosure provides various aspects of electronic fireplace units. Accordingly, the present disclosure discloses a fireplace unit including: a housing including a blower vent, a floor panel and an electrical housing area; a first visual display panel within the housing, the first visual display panel configured to display a static image, a dynamic image or a video; a heating unit configured to provide a heating source for the fireplace unit; and a power supply coupled to the heating unit and the at least one visual display panel, the power supply configured to supply electrical energy to the heating unit and the at least one visual display panel.

In one example, the housing is of a rectangular shape with a back side, a right side parallel to a left side, a top side parallel to a bottom side; and wherein the first visual display panel is parallel to the back side.

In one example, the fireplace unit further includes a second display panel parallel to the right side and a third display panel parallel to the left side; and wherein the second display panel and the first display panel are orthogonal; and wherein the third display panel and the first display panel are orthogonal.

In one example, the first visual display panel is a curved shape. In one example, the first visual display panel is a concave shape. In one example, the fireplace unit further includes a concave shaped polarized glass positioned adjacent to the first visual display panel. In one example, the fireplace unit further includes a floor panel which is a visual display panel in a curved shape that matches the concave shape of the first visual display panel, wherein the floor panel includes a reflective glass. In one example, the fireplace unit further includes a fan module located within the housing.

Another aspect of the disclosure provides a fireplace unit including: a housing including a blower vent, a floor panel and an electrical housing area; a first visual display panel, a second visual display panel and a third visual display within the housing, wherein the first visual display panel, the second visual display panel and the third visual display panel are configured to display a static image, a dynamic image or a video; a heating unit configured to provide a heating source for the fireplace unit; and a power supply coupled to the heating unit, the first visual display panel, the second visual display panel and the third visual display panel, the power supply configured to supply electrical energy to the heating unit, the first visual display panel, the second visual display panel and the third visual display panel.

These and other aspects of the present disclosure will become more fully understood upon a review of the detailed description, which follows. Other aspects, features, and implementations of the present disclosure will become apparent to those of ordinary skill in the art, upon reviewing the following description of specific, exemplary implementations of the present disclosure in conjunction with the accompanying figures. While features of the present disclosure may be discussed relative to certain implementations and figures below, all implementations of the present disclosure can include one or more of the advantageous features discussed herein. In other words, while one or more implementations may be discussed as having certain advantageous features, one or more of such features may also be used in accordance with the various implementations of the disclosure discussed herein. In similar fashion, while exemplary implementations may be discussed below as device, system, or method implementations it should be understood that such exemplary implementations can be implemented in various devices, systems, and methods.

### BRIEF DESCRIPTION OF THE DRAWINGS

FIG. 1 illustrates an example of a fireplace unit with three visual display panels.

FIG. 2 illustrates an example of the placements of the three visual display panels relative to the housing of fireplace unit of FIG. 1.

FIG. 3 illustrates an example top view of the fireplace unit.

FIG. 4 illustrates an example fireplace unit which includes a display unit within a housing.

FIG. 5 illustrates an example of a fireplace unit with polarized glasses.

FIG. 6 illustrates an example of a fireplace unit with angled side visual display panels.

FIG. 7 illustrates an example of a fireplace unit with angled side visual display panels and polarized glasses.

FIG. 8 illustrates an example of a fireplace unit with a rear curved visual display panel.

FIG. 8A illustrates example concave structures.

FIG. 8B illustrates an example of a diverging optical geometry for an example concave structure.

FIG. 8C illustrates an example of a converging optical geometry for an example concave structure.

FIG. 8D illustrates an example of a concave structure with a first focal point with a first focal length and a conjugate focal point with a conjugate focal length.

FIG. 9 illustrates an example of a fireplace unit with a rear curved visual display panel and a polarized glass.

FIG. 10 illustrates a top view of an example fireplace unit with a housing, three visual display panels, a blower vent and an electrical housing area for housing electrical components.

FIG. 11 illustrates a top view of an example fireplace unit with a housing, three visual display panels, polarized glasses, a blower vent and an electrical housing area for housing electrical components.

FIG. 12 illustrates a top view of an example fireplace unit with a housing, three visual display panels, a blower vent and an electrical housing area for housing electrical components.

FIG. 13 illustrates a top view of an example fireplace unit with a housing, three visual display panels connected to each other at angles more than 90 degrees, polarized glasses, a blower vent and an electrical housing area for housing electrical components.

FIG. 14 illustrates a top view of an example fireplace unit with a curved visual display panel, a blower vent and an electrical housing area for housing electrical components.

FIG. 15 illustrates a top view of an example fireplace unit with a curved visual display panel, a curved polarized glass, a blower vent and an electrical housing area for housing electrical components.

FIG. 16 illustrates an example fireplace unit in a curved screen configuration.

FIG. 17 illustrates an example fireplace unit in a flat screen configuration.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well-known structures and components are shown in block diagram form in order to avoid obscuring such concepts.

While for purposes of simplicity of explanation, the methodologies are shown and described as a series of acts, it is to be understood and appreciated that the methodologies are not limited by the order of acts, as some acts may, in accordance with one or more aspects, occur in different orders and/or concurrently with other acts from that shown and described herein. For example, those skilled in the art will understand and appreciate that a methodology could alternatively be represented as a series of interrelated states or events, such as in a state diagram. Moreover, not all illustrated acts may be required to implement a methodology in accordance with one or more aspects.

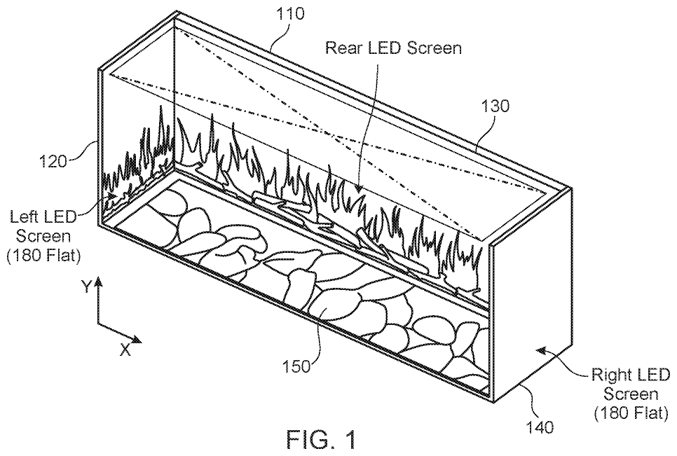

FIG. 1 illustrates an example of a fireplace unit 100 with three visual display panels. As illustrated in the example, the fireplace unit 100 includes a housing 110, three visual display panels 120, 130, 140. In FIG. 1, the front side of visual display panel 120 is shown and the back side of visual display panel 140 is shown. In one example, the three visual display panels are separate from the housing 110. In another example, the three visual display panels 120, 130, 140 make up the side panels of the housing 110. In one example, the housing 110 includes a floor panel 150 which may or may not be a visual display panel.

As shown in FIG. 1, visual display panel 120 is connected to visual display panel 130 at one edge of each visual display panel. And, visual display panel 140 is connected to visual display panel 130 at another edge of the visual display panel 130. In one example, the connection of visual display panel 120 to visual display panel 130 is at a perpendicular angle (e.g., ~90 degrees). In one example, the connection of visual display panel 140 to visual display panel 130 is at a perpendicular angle (e.g., ~90 degrees). In one example, the floor panel 150 is connected to the three visual display panels 120, 130 and 140 at different edges of the floor panel 150 and the connection is at a perpendicular angle (e.g., ~90 degrees).

In one example, each visual display panel may operate and may be controlled independently from the other visual display panels in displaying image(s). That is, one visual display panel may display an image, while another visual display panel may be “off” (i.e., not displaying an image). Or, each visual display panel may display a different image. In one example, each visual display panel may be configured to display a static image, a dynamic image or a video independently or the group of visual display panels (as connected together) may be configured to display together a static image, a dynamic image or play a video as one large screen.

In one example, the three visual display panels 120, 130, 140 display a continuous image that spans from approximately 0 degrees to 180 degrees on a horizontal axis X. In the example where the floor panel 150 is also a visual display panel, a continuous image may be displayed that span from approximately 0 degrees to 180 degrees on a vertical axis Y. Note that the dimensions of the fireplace unit 100 as shown in FIG. 1 are in the dimension of millimeters (mm) and are examples. In another example, the fireplace unit 100 may have the following dimensions: height 20 inches, width 50 inches and depth 12 inches. That is, other dimensions of the fireplace unit 100 are also within the scope and spirit of the present disclosure. In another example, the fireplace unit 100 may have the following dimensions: height 20 inches, width 50 inches and depth 12 inches.

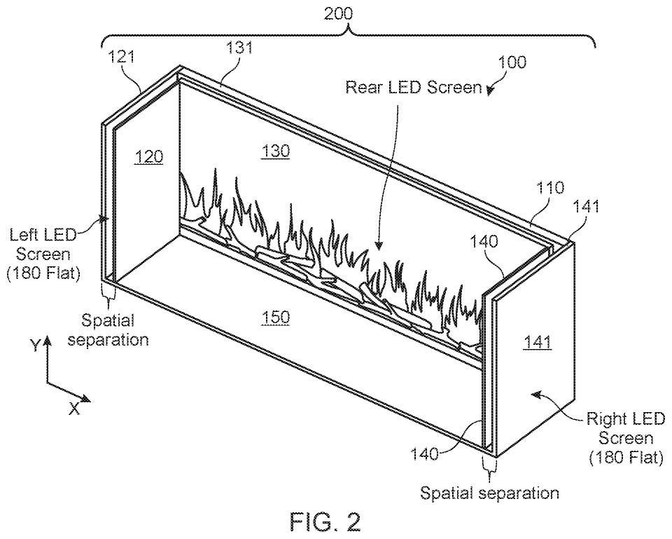

FIG. 2 illustrates an example 200 of the placements of the three visual display panels 120, 130, 140 relative to the housing 110 of fireplace unit 100 of FIG. 1. As shown in FIG. 2, there's a spatial separation between the housing 110 to each of the three visual display panels 120, 130, 140. The dimensions of each spatial separation between the housing 110 to each of the three visual display panels 120, 130, 140 may be a design choice. And, in one example, the spatial separation between the housing 110 and the visual display panel 120, the spatial separation between the housing 110 and the visual display panel 130, and the spatial separation between the housing 110 and the visual display panel 140 may be the same or may differ from one another.

In one example, the visual display panel 130 is curved in the horizontal direction (via horizontal axis X) while the visual display panels 120, 140 are flat visual display panels. And, in one example, the visual display panels 120, 130, 140 may or may extend the entire height of its corresponding side panels 121, 131, 141 of the housing 110. As an example, FIG. 2 shows that the visual display panels 120, 140 are not displaying an image while visual display panel 130 displays an image. In one example, the image display on the visual display panel 130 reaches only about half the height of the side panel 131.

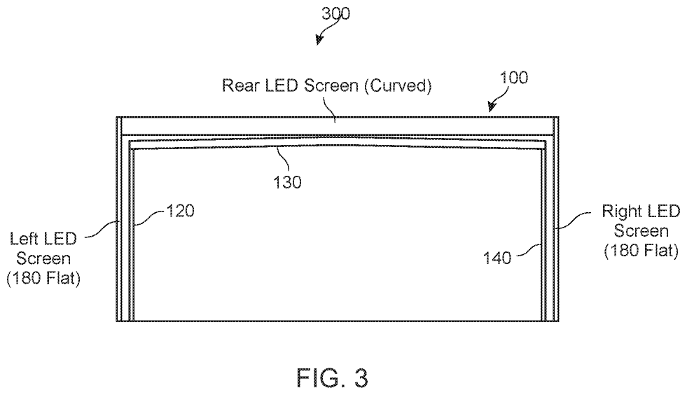

FIG. 3 illustrates an example top view 300 of the fireplace unit 100. In the example of FIG. 3, the visual display panels 120, 140 are flat panels while the visual display panel 130 is curved. However, curved visual display panels on the sides (i.e., visual display panels 120, 140) are also within the scope and spirit of the present disclosure. The dimensions presented in FIG. 3 are examples only and do not exclude other dimensions which may better fit a particular design choice. In one example, the curvature of visual display panel 130 may be deduced from the example dimensions shown in FIG. 3.

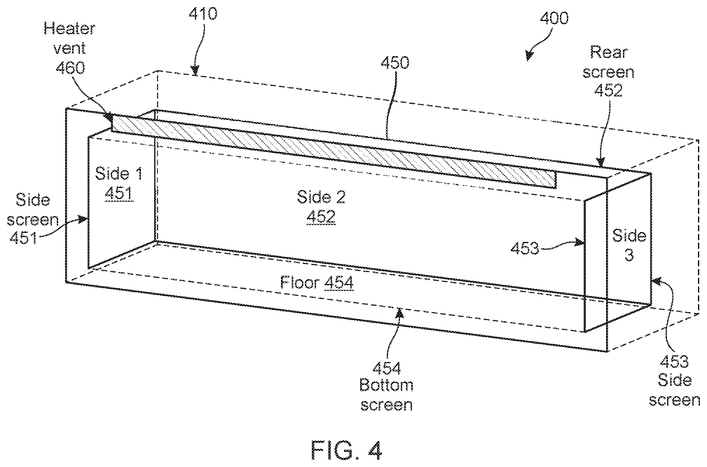

FIG. 4 illustrates an example fireplace unit 400 which includes a display unit 450 within a housing 410. In one example, the display unit 450 include 3 sides connected to each other, and an open side opposite to side 2. For example, side 1 is a visual display screen 451, side 2 is a visual display screen 452, and side 3 is a visual display screen 453. In one example, the display unit 450 include a floor. The floor, in one example, is a visual display screen 454. In one example, the visual display screens 451, 452, 453 and 454 (if the floor is a visual display screen) will operate to display a visual image (or visual streaming) as one contiguous unit. This is in contrast to the individual visual display panels of FIG. 1, wherein each visual display panel may operate independently from the other visual display panels in displaying image(s). Although one skilled in the art would understand that the visual display panels (as disclosed herein) may also operate together with other visual display panels to display a visual image (or visual streaming) as one contiguous unit.

In one example, the housing 410 includes a heater vent 460 to provide vent openings (not shown) for air flow through the housing 410. The dimensions and shapes of the vent openings are design choices for optimum air flow. For example, heated air flows out of the housing 410 and cold air flow in from the surrounding area.

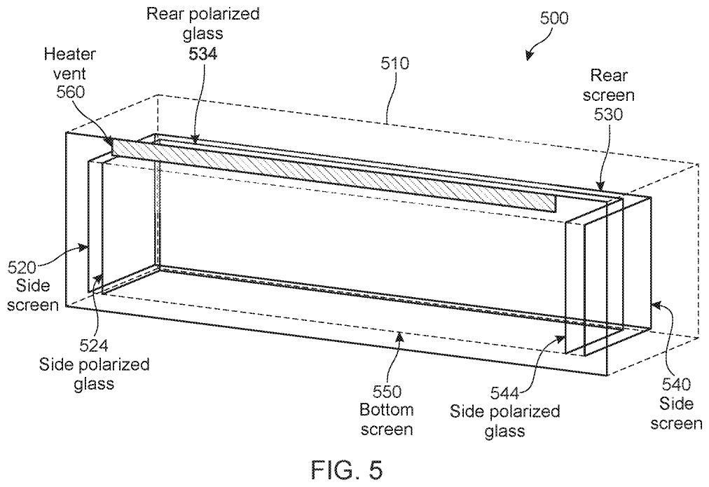

FIG. 5 illustrates an example of a fireplace unit 500 with polarized glasses 524, 534, 544. As shown in FIG. 5, the fireplace unit 500 includes a housing 510, a heater vent 560, and visual display panels 520, 530, 540 (a.k.a., side screen 520, rear screen 530, side screen 540). In one example, the floor panel is also a visual display screen 550 (a.k.a., bottom screen 550). In one example, the visual display panels may be replaced by a display unit (similar to the display unit 450).

Shown in FIG. 5 are polarized glasses. A side polarized glass 524 is positioned in front of visual display panel 520. A side polarized glass 524 is positioned in front of visual display panel 520. A rear polarized glass 534 is positioned in front of visual display panel 530. A second side polarized glass 544 is positioned in front of visual display panel 540. Although no polarized glass is shown for the visual display screen 550 (i.e., floor panel or a.k.a., bottom screen 550), a polarized glass may be added for the visual display screen 550. In the example as shown in FIG. 5, the position of the polarized glasses “in front” of each respective visual display panel means that each visual display panel is positioned between a side of the housing 510 and the visual display panel's corresponding polarized glass.

In one example, the purpose of the polarized glasses is reduction of glare. In one example, polarized glass exploits polarization (i.e., electric field direction of reflected light to reduce glare).

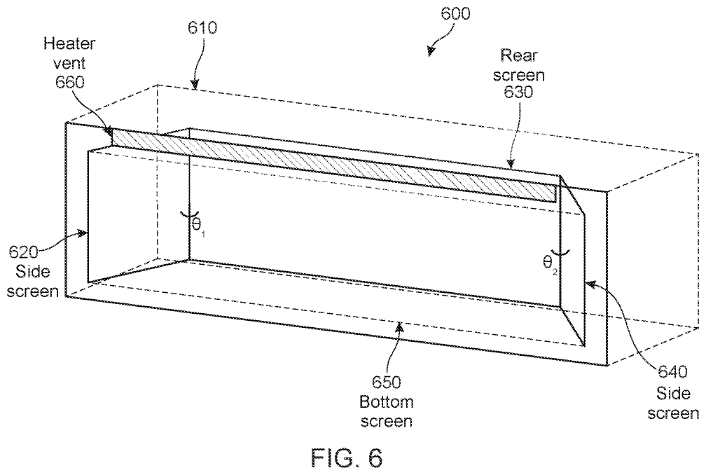

FIG. 6 illustrates an example of a fireplace unit 600 with angled side visual display panels 620, 640. The example fireplace unit 600 includes a housing 610, a heater vent 660 and visual display panels 620, 630 and 640. In one example, a portion of the floor of the housing 610 is a visual display screen 650. As illustrated in FIG. 6, the visual display panels 620, 640 are connected to the visual display panel 630 at an angle (e.g., respective, θ₁ or θ₂). In one example, θ₁ equals θ_{2.}. In another example, θ₁ does not equal θ₂. In one example, the shape and dimension of visual display panel 650 (a.k.a., bottom screen 650) is dictated by the contour formed by the connection of visual display panels 620, 630, 640 and the angles θ₁ and θ₂. Note that visual display panels 620, 640 may be labeled as side screens, while visual display panel 630 may be labeled as a rear screen, and visual display panel 650 may be labeled as a bottom screen.

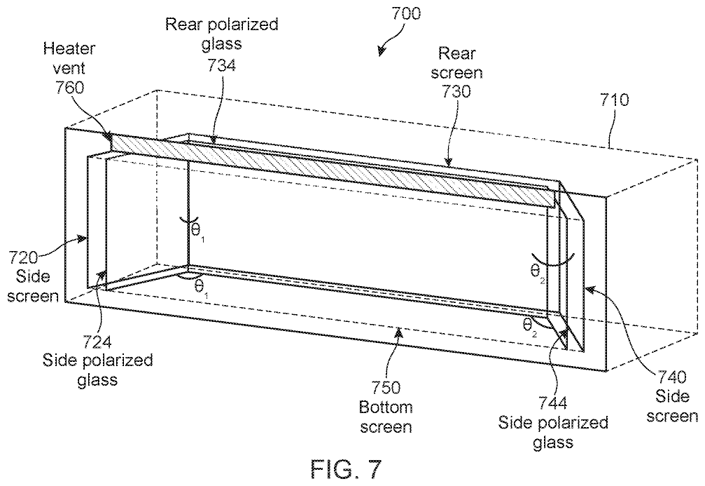

FIG. 7 illustrates an example of a fireplace unit 700 with angled side visual display panels 720, 740 and polarized glasses 724, 734, 744. The example fireplace unit 700 includes a housing 710, a heater vent 760 and visual display panels 720, 730 and 740. In one example, a portion of the floor of the housing 710 is a visual display screen 750. The visual display panels 720, 740 may be labeled as side screens, while visual display panel 730 may be labeled as a rear screen, and visual display panel 750 may be labeled as a bottom screen.

As illustrated in FIG. 7, the visual display panels 720, 740 are connected to the visual display panel 730 at an angle. That is, the visual display panel 720 is connected to the visual display panel 730 at an angle θ₁. And, the visual display panel 740 is connected to the visual display panel 730 at an angle θ₂.

A polarized glass 724 (a.k.a. side polarized glass) is positioned in front of visual display panel 720. A polarized glass 734 (a.k.a. rear polarized glass) is positioned in front of visual display panel 730. A polarized glass 744 (a.k.a. side polarized glass) is positioned in front of visual display panel 740. To correspond with the angle positioning of visual display panels 720, 740, the side polarized glass 724 is connected to the rear polarized glass 734 at the angle θ₁. And, side polarized glass 744 is connected to the rear polarized glass 734 at the angle θ₂.

In one example, angle θ₁ equals angle θ_{2.}. In another example, angle θ₁ does not equal angle θ₂. In one example, the shape and dimension of visual display panel 750 (a.k.a., bottom screen 750) is dictated by the contour formed by the connection of visual display panels 720, 730, 740 and the angles θ₁ and θ₂.

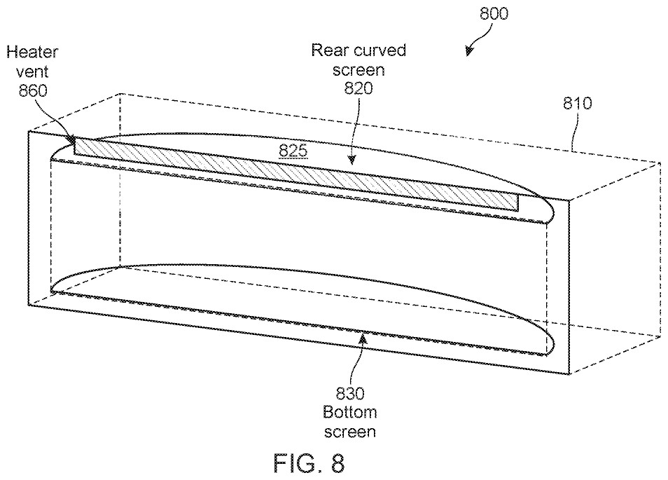

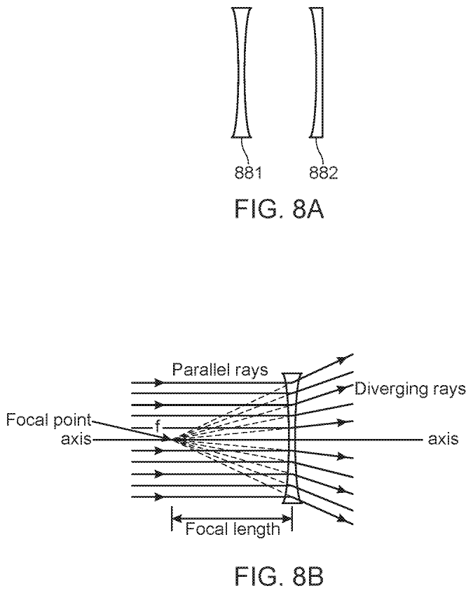

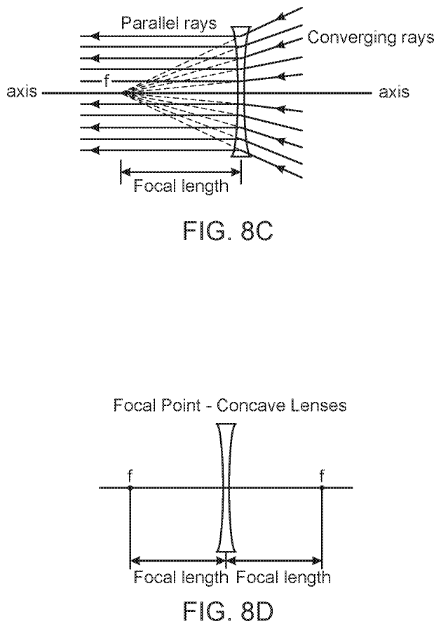

FIG. 8 illustrates an example of a fireplace unit 800 with a rear curved visual display panel 820 (a.k.a., rear curved screen). In one example, the fireplace unit 800 may also include a bottom visual display panel 830 (a.k.a., bottom screen). In one example, the rear curved visual display panel 820 may be controlled to display an image independently of the bottom visual display panel 830. For example, one of the two panels 820, 830 may display an image while the other does not. Or, for example, each of the two panels 820, 830 may display different images simultaneously. In another example, the rear curved visual display panel 820 and the bottom visual display panel 830 may together display a continuous image such that the entirety of the image is shown seamlessly using both panels 820 and 830.

In one example, the fireplace unit 800 may include an optional ceiling panel 825 that fits to the rear curved visual display panel 820. And, in one example, the transparent ceiling panel 825 has the same shape and dimensions as the bottom visual display panel 830. The ceiling panel 825 may function as a structural support for the rear curved visual display panel 820. In one example, the ceiling panel 825 is transparent. The example fireplace unit 800 includes a housing 810 and a heater vent 860.

In one example, the curved shape of the visual display panel 820 may be a concave shape. In one example, a concave shape is a three-dimensional structure where a width in an axial dimension is narrower in the center than in the top edge and the bottom edge. FIG. 8A illustrates example concave structures, where a first concave structure 881 includes two symmetric concave shapes and a second concave structure 882 includes one concave shape.

In one example, the concave shape has a first optical property where an incident parallel electromagnetic wave (e.g., light beam) is transformed into an outgoing diverging electromagnetic wave. In one example, the concave shape has a second optical property where an incident converging electromagnetic wave is transformed into an outgoing parallel electromagnetic wave.

In one example, the diverging electromagnetic wave from the concave shape has a first focal point which is an apparent source of the diverging electromagnetic wave. In one example, the concave shape also has a first focal length which is a linear distance from the first focal point to the center of the concave shape. FIG. 8B illustrates an example of a diverging optical geometry for an example concave structure.

In one example, the converging electromagnetic wave incident on the concave shape has a second focal point which is an apparent sink of the converging electromagnetic wave. In one example, the concave shape also has a second focal length which is a linear distance from the center of the concave shape to the second focal point. FIG. 8C illustrates an example of a converging optical geometry for an example concave structure. In one example, the first focal point and the second focal point are the same. In one example, the first focal length and the second focal length are the same.

In one example, the concave shape has a conjugate focal point on an opposite side of the concave shape. In one example, the conjugate focal point has a conjugate focal length which is equal to the first focal length (or second focal length). FIG. 8D illustrates an example of a concave structure with a first focal point with a first focal length and a conjugate focal point with a conjugate focal length.

In one example, the first focal point and the conjugate focal point are both virtual focal points. For example, a virtual focal point does not act as an actual focusing location for electromagnetic waves, but appears as a source or sink of electromagnetic waves based on the optical geometry of the concave structure.

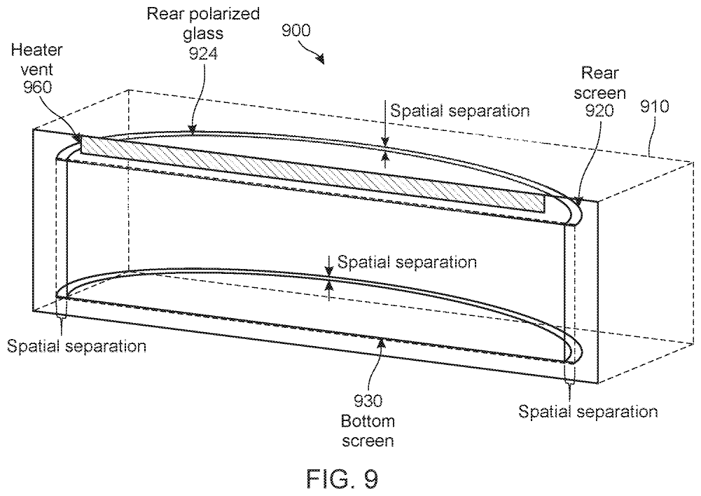

FIG. 9 illustrates an example of a fireplace unit 900 with a rear curved visual display panel 920 (a.k.a., rear curved screen) and a polarized glass 924 (a.k.a., rear polarized glass). In one example, the fireplace unit 900 may also include a bottom visual display panel 930 (a.k.a., bottom screen). In one example, the rear curved visual display panel 920 may be controlled to display an image independently of the bottom visual display panel 930. For example, one of the two panels 920, 930 may display an image while the other does not. Or, for example, each of the two panels 920, 930 may display different images simultaneously. In another example, the rear curved visual display panel 920 and the bottom visual display panel 930 may together display a continuous image such that the entirety of the image is shown seamlessly using both panels 920 and 930.

In one example, the polarized glass 924 is curved in the same manner as the rear curved visual display panel 920. That is, the polarized glass 924 includes dimensions and curvatures that would allow it to be positioned in front of the rear curved visual display panel 920 with a uniform spacing (i.e., spatial separation) between the two (i.e., between the rear curved visual display panel 920 and the polarized glass 924). The dimensions of the spatial separation between the rear curved visual display panel 920 and the polarized glass 924 may be a design choice. The example fireplace unit 900 includes a housing 910 and a heater vent 960.

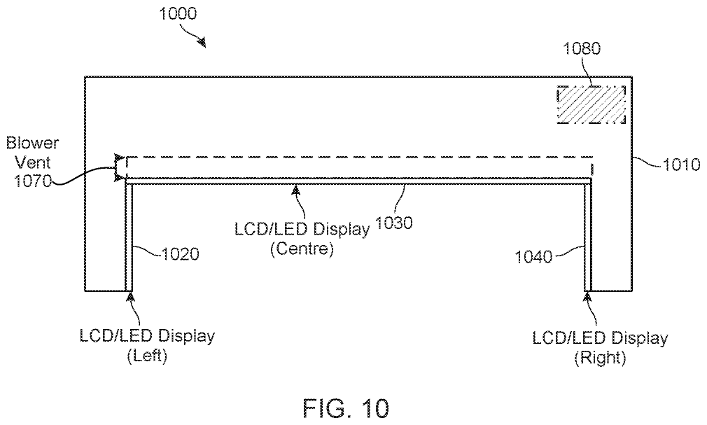

FIG. 10 illustrates a top view of an example fireplace unit 1000 with a housing 1010, three visual display panels 1020, 1030, 1040, a blower vent 1070 and an electrical housing area 1080 for housing electrical components. In one example, the visual display panels 1020, 1030, 1040 are liquid crystal display (LCD) or light emitting diode (LED) display screens. In one example, the three visual display panels 1020, 1030, 1040 may be replaced by a display unit similar to the display unit 450 shown in FIG. 4.

In one example, the blower vent 1070 is positioned adjacent to the visual display panel 1030. In one example, the function of the blower vent 1070 is to improve convection heat transport for a more uniform temperature distribution. In one example, the heater vent and the blower vent as disclosed in the present disclosure may have the same function. And, in some examples, their locations, shapes and/or dimensions may be the same or differ depending on design choices.

The length and height dimensions of the blower vent 1070 may vary depending on design choice. In one example, the height dimension of the blower vent 1070 is the same as the height dimension of the visual display panel 1030. In another example, the height dimension of the blower vent 1070 is less than the height dimension of the visual display panel 1030. In one example, the width dimension of the blower vent 1070 extends the entire length of the visual display panel 1030. In one example, the width dimension of the blower vent 1070 is less than the dimension of the entire length of the visual display panel 1030.

In one example, the electrical housing area 1080 houses electrical components for controlling and monitoring one or more of the following: the visual display panels 1020, 1030, 1040 and/or the blower vent 1070 The electrical components may include one or more heat controllers, heating source(s) and/or power supplies for controlling and monitoring the visual display panels and/or blower vent and for generating heat for the fireplace unit 1000. In one example, the fireplace unit consumes up to 1800 Watts with the following: current of 15 amps, voltage of 120 volts and single phase. In another example, the fireplace unit consumes 2400 Watts with the following: current up to 20 amps, voltage of 120 volts and single phase. In one example, the electrical components include any device which consume electrical energy.

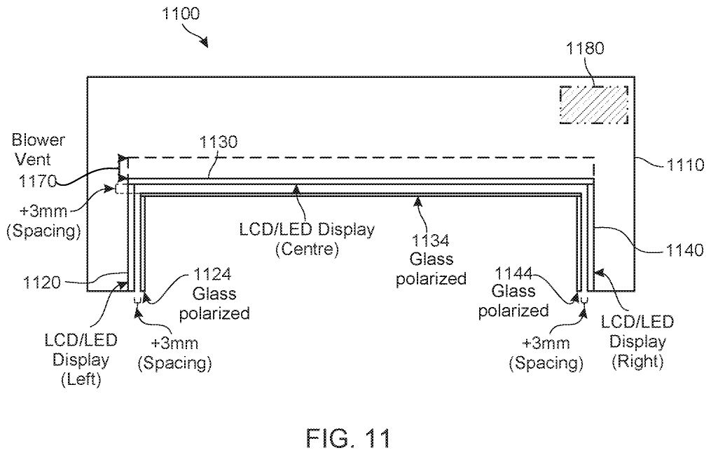

FIG. 11 illustrates a top view of an example fireplace unit 1100 with a housing 1110, three visual display panels 1120, 1130, 1140, three polarized glasses 1124, 1134, 1144, a blower vent 1170 and an electrical housing area 1180 for housing electrical components. The fireplace unit 1100 is similar to the fireplace unit 1000 of FIG. 10 except that it includes three polarized glasses 1124, 1134, 1144 which are positioned in front of the respective three visual display panels 1120, 1130, 1140. As shown in FIG. 11, there is a spacing (i.e., spatial separation) between the visual display panels and the polarized glasses. The dimension of the spacing shown in FIG. 11 is an example and other dimension of the spacing is within the scope and spirit of the present disclosure.

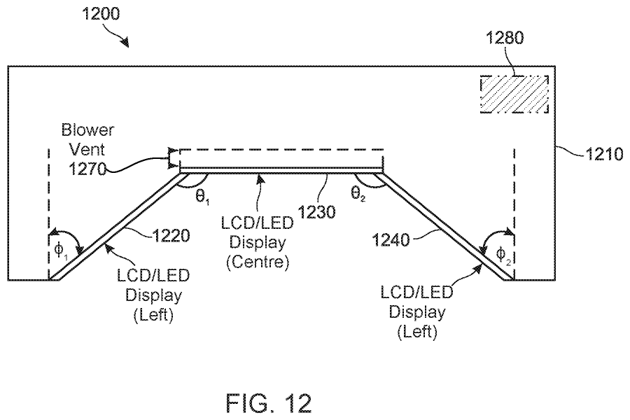

FIG. 12 illustrates a top view of an example fireplace unit 1200 with a housing 1210, three visual display panels 1220, 1230, 1240 connected to each other at angles less than 90 degrees, a blower vent 1270 and an electrical housing area 1280 for housing electrical components. In one example, the visual display panels 1220, 1230, 1240 are liquid crystal display (LCD) or light emitting diode (LED) display screens.

The electrical components housed within the electrical housing area 1280 may include all the components disclosed in FIG. 10. As shown in FIG. 12, the length dimension of the blower vent is the same as the length dimension of the visual display panel 1230. In another example, the length dimension of the blower vent may be less than the length dimension of the visual display panel 1230. In yet another example, the length dimension of the blower vent may be greater than the length dimension of the visual display panel 1230.

In one example, the height dimension of the blower vent 1270 is the same as the height dimension of the visual display panel 1230. In another example, the height dimension of the blower vent 1270 is less than the height dimension of the visual display panel 1230. The length and height dimensions of the blower vent 1270 may vary depending on design choice.

As shown in FIG. 12, visual display panel 1220 is connected to visual display panel 1230 at an angle θ₁. Angle θ₁ is the compliment of angle phi φ₁. That is, the sum of angle θ₁ and angle phi φ₁ equals 90 degrees. As shown in FIG. 12, visual display panel 1240 is connected to visual display panel 1230 at an angle θ₂. Angle θ₂ is the compliment of angle phi φ₂. That is, the sum of angle θ₂ and angle phi φ₂ equals 90 degrees. The ranges for angle phi φ₁ and angle phi φ₂ are examples. Other ranges for the angle phi φ₁ and angle phi φ₂ are within the scope and spirit of the present disclosure. In one example, angles phi φ₁ and phi φ₂ may range from 20 to 52.3 degrees.

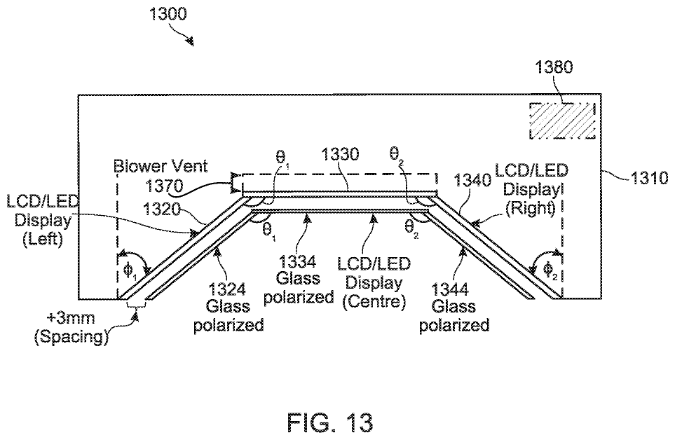

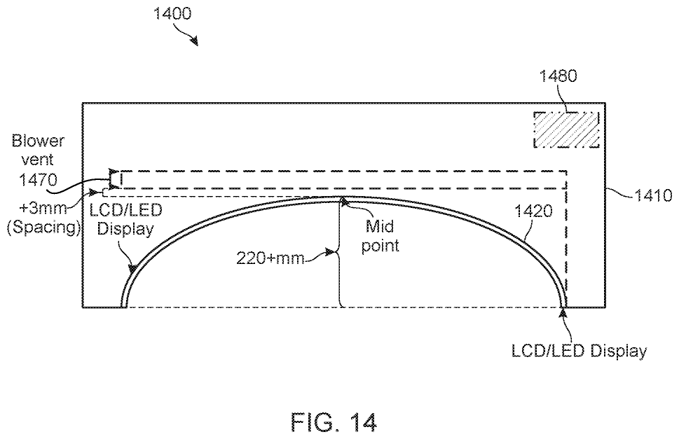

FIG. 13 illustrates a top view of an example fireplace unit 1300 with a housing 1310, three visual display panels 1320, 1330, 1340 connected to each other at angles less than 90 degrees, polarized glasses 1324, 1334, 1344, a blower vent 1370 and an electrical housing area 1380 for housing electrical components.

The fireplace unit 1300 is similar to the fireplace unit 1200 of FIG. 12 except that it includes three polarized glasses 1324, 1334, 1344 which are positioned in front of the respective three visual display panels 1320, 1330, 1340. As shown in FIG. 13, there is a spacing (i.e., spatial separation) between the visual display panels and the polarized glasses. The dimension of the spacing shown in FIG. 13 is an example and other dimension of the spacing is within the scope and spirit of the present disclosure.

As shown in FIG. 13, visual display panel 1320 is connected to visual display panel 1330 at an angle θ₁. Angle θ₁ is the compliment of angle phi φ₁. That is, the sum of angle θ₁ and angle phi φ₁ equals 90 degrees. As shown in FIG. 13, visual display panel 1340 is connected to visual display panel 1330 at an angle θ₂. Angle θ₂ is the compliment of angle phi φ₂. The ranges for angle phi φ₁ and angle phi φ₂ are examples. Other ranges for the angle phi φ₁ and angle phi φ₂ are within the scope and spirit of the present disclosure. In one example, angles phi φ₁ and phi φ₂ may range from 20 to 52.3 degrees.

The three polarized glasses 1324, 1334, 1344 are positioned in front of their corresponding visual display panels 1320, 1330, 1340. The polarized glass 1324 is also connected to polarized glass 1334 at an angle θ₁. And, the polarized glass 1344 is also connected to polarized glass 1334 at an angle θ₂.

FIG. 14 illustrates a top view of an example fireplace unit 1400 with a curved visual display panel 1420, a blower vent 1470 and an electrical housing area 1480 for housing electrical components. The electrical components housed within the electrical housing area 1480 may include all the components disclosed in FIG. 10. In one example, the curved visual display panel 1420 is a liquid crystal display (LCD) or a light emitting diode (LED) display screen. As shown in FIG. 14, the shape of the example blower vent 1470 from a top view is a rectangular shape and does not follow the contour of the curved visual display panel 1420. Although the length dimension of the blower vent 1470 is shown to extend almost the entire length of the housing 1410, other length dimensions of the blower vent 1470 are also within the scope and spirit of the present disclosure. That is, in another example, the length dimension of the blower vent 1470 may be less than the length of the housing by a percentage to be determined by design choice. As shown in FIG. 14, there is a spacing (i.e., spatial separation) between the blower vent 1470 and the midpoint of the curved visual display panel 1420. The dimension of this spacing, as shown in FIG. 14, is an example and other dimensions of the spacing are within the scope and spirit of the present disclosure.

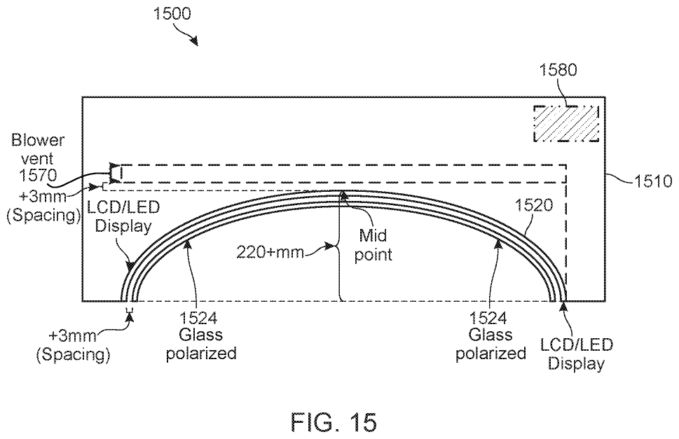

FIG. 15 illustrates a top view of an example fireplace unit 1500 with a curved visual display panel 1520, a curved polarized glass 1524, a blower vent 1570 and an electrical housing area 1580 for housing electrical components. The fireplace unit 1500 is similar to the fireplace unit 1400 of FIG. 14 except that it includes a curved polarized glass 1524 which is positioned in front of the respective three visual display panels. As shown in FIG. 15, there is a spacing (i.e., spatial separation) between the curved visual display panel 1520 and the curved polarized glass 1524. The dimension of this spacing, as shown in FIG. 15, is an example and other dimensions of the spacing are within the scope and spirit of the present disclosure.

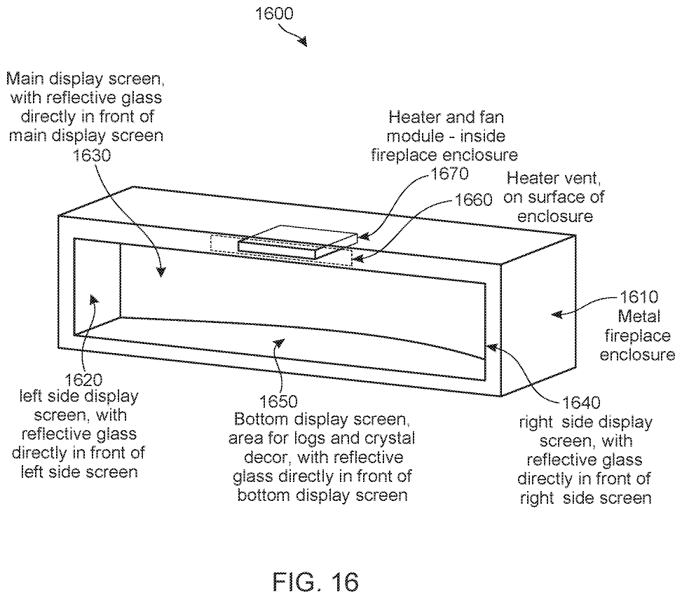

FIG. 16 illustrates an example fireplace unit 1600 in a curved screen configuration. In one example, the example fireplace unit 1600 in a curved screen configuration includes a metal fireplace enclosure 1610 with a left side display screen 1620, a main display screen 1630 and a right side display screen 1640. In one example, the left side display screen 1620 includes a reflective glass cover directly in front of the left side display screen 1620. In one example, the main display screen 1630 includes a reflective glass directly in front of the main display screen 1630. In one example, the right side display screen 1640 includes a reflective glass directly in front of the right side display screen 1640. In one example, a reflective glass is a glass material which includes a layer of high reflectivity to reduce glare. In one example, high reflectivity is a reflection coefficient greater than a reflectivity threshold (e.g., 0.50).

In one example, the fireplace enclosure 1610 includes three sides connected to each other, and an open side opposite to the main display screen 1630. In one example, the fireplace enclosure 1610 includes a floor. The floor, in one example, is a bottom display screen 1650. In one example, the display screens 1620, 1630, 1640 and 1650 (e.g., if the floor is a bottom visual display screen 1650) will operate to display a visual image as one unit. Alternately, each display screen may operate independently from the other display screens in displaying an individual image. In one example, 1650 is a bottom display screen which may be used for storage of logs and may include crystal decorations and/or a reflective glass (for example).

In one example, the fireplace enclosure 1610 includes a heater vent 1660, on an enclosure surface of the fireplace enclosure 1610, to provide vent openings (not shown) for air flow through the fireplace enclosure 1610. The dimensions and shapes of the vent openings are design choices for optimum air flow. For example, heated air flows out of the fireplace enclosure 1610 and cold air flows in from the surrounding environment.

In one example, the fireplace enclosure 1610 includes a heater and fan module 1670 inside the fireplace enclosure 1610. In one example, the heater and fan module 1670 includes a heating source (e.g., convective, radiative, conductive, etc.) and a fan for convective cooling.

In one example, the main display screen 1630 is configured as a curved screen. In one example, the curved screen is specified with a finite radius of curvature.

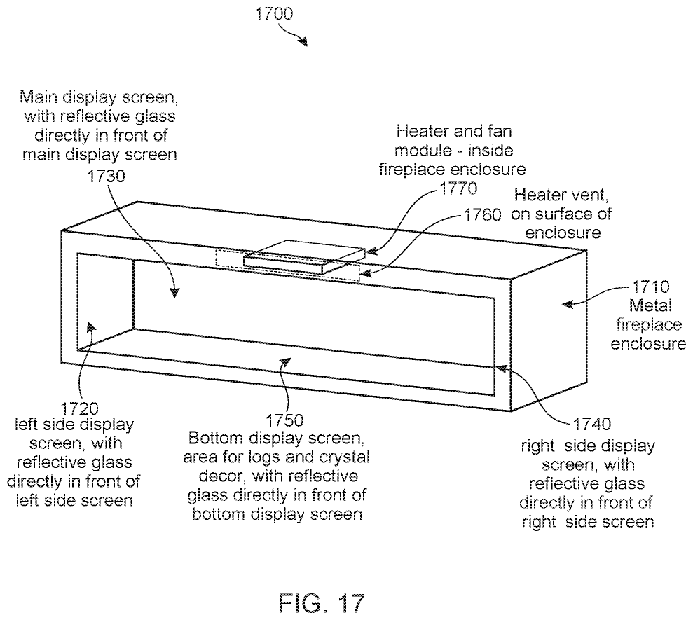

FIG. 17 illustrates an example fireplace unit 1700 in a flat screen configuration. In one example, the example fireplace unit 1700 in a flat screen configuration includes a metal fireplace enclosure 1710 with a left side display screen 1720, a main display screen 1730 and a right side display screen 1740. In one example, the left side display screen 1720 includes a reflective glass cover directly in front of the left side display screen 1720. In one example, the main display screen 1730 includes a reflective glass directly in front of the main display screen 1730. In one example, the right side display screen 1740 includes a reflective glass directly in front of the right side display screen 1740. In one example, a reflective glass is a glass material which includes a layer of high reflectivity to reduce glare. In one example, high reflectivity is a reflection coefficient greater than a reflectivity threshold (e.g., 0.50).

In one example, the fireplace enclosure 1710 includes three sides connected to each other, and an open side opposite to the main display screen 1730. In one example, the fireplace enclosure 1710 includes a floor. The floor, in one example, is a bottom display screen 1750. In one example, the display screens Y20, Y30, Y40 and Y50 (e.g., if the floor is a bottom visual display screen 1750) will operate to display a visual image as one unit. Alternately, each display screen may operate independently from the other display screens in displaying an individual image. In one example, 1750 is a bottom display screen which may be used for storage of logs and may include crystal decorations and/or a reflective glass (for example).

In one example, the fireplace enclosure 1710 includes a heater vent 1760, on an enclosure surface of the fireplace enclosure 1710, to provide vent openings (not shown) for air flow through the fireplace enclosure 1710. The dimensions and shapes of the vent openings are design choices for optimum air flow. For example, heated air flows out of the fireplace enclosure 1710 and cold air flows in from the surrounding environment.

In one example, the fireplace enclosure 1710 includes a heater and fan module 1770 inside the fireplace enclosure 1710. In one example, the heater and fan module 1770 includes a heating source (e.g., convective, radiative, conductive, etc.) and a fan for convective cooling.

In one example, the main display screen 1730 is configured as a flat screen. In one example, the flat screen is specified with an infinite radius of curvature.

In FIGS. 16 and 17, the term “display screen” is the same as “visual display panel” used in the other figures in the present disclosure. One skilled in the art would understand that although some dimensions are disclosed herein and/or listed in the figures, the dimensions are not exclusive and are examples only. Thus, other dimensions for the particular components (e.g., as other dimensions may be more suitable for a particular design choice or application) are also within the scope and spirit of the present disclosure.

In one example, any of the example fireplace units may include a heating unit (not shown) as a heat source. For example, the heating unit may be an electric fan-forced heater or an electric infrared heater. In one example, the electric fan-forced heater uses an electric heater to convert electric energy to heat energy. For example, the electric fan-forced heater includes a power supply to provide dc electric power as an energy source and an electric fan to propel heat energy convectively from the heater to its vicinity.

In one example, the electric infrared heater uses an infrared source to convert electric energy to infrared energy as heat energy. For example, the electric infrared heater includes a power supply to provide dc electric power as an energy source. In one example, the infrared source radiates the heat energy from the fireplace unit to its vicinity.

In one example, the heating unit may be positioned within the enclosure of the housing of the fireplace unit. In another example, the heating unit may be external to the housing of the fireplace unit; that is, the heating unit may be positioned outside the housing.

In one example, the electrical housing area 1080, 1180, 1280, 1380, 1480, 1580 houses a temperature setting unit for controlling the operating temperature of the heating unit. In one example, the electrical housing area 1080, 1180, 1280, 1380, 1480, 1580 houses a first set of ON/OFF switch that controls the heating unit. In one example, the electrical housing area 1080, 1180, 1280, 1380, 1480, 1580 houses a second set of ON/OFF switch that controls the display panel(s). One skilled in the art would understand that more than one set of ON/OFF switch may be used to control more than one display panel. In one example, the electrical housing area 1080, 1180, 1280, 1380, 1480, 1580 houses a third set of ON/OFF switch that controls the blower vent.

In one example, any electronic functionality of any component of the example fireplace units disclosed herein may be performed by one or more of the following: a processing engine, a processor, a microprocessor, a microcontroller, a controller, a central processing unit (CPU), a digital signal processor (DSP), a graphics processing unit (GPU), a display processing unit (DPU), etc.

In one example, the disclosure discloses a fireplace unit including: a housing including a blower vent, a floor panel and an electrical housing area; a first visual display panel within the housing, the first visual display panel configured to display a static image, a dynamic image or a video; a heating unit configured to provide a heating source for the fireplace unit; and a power supply coupled to the heating unit and the at least one visual display panel, the power supply configured to supply electrical energy to the heating unit and the at least one visual display panel.

In one example, the housing is of a rectangular shape with a back side, a right side parallel to a left side, a top side parallel to a bottom side; and wherein the first visual display panel is parallel to the back side. In one example, the fireplace unit further includes a second display panel parallel to the right side and a third display panel parallel to the left side; and wherein the second display panel and the first display panel are orthogonal; and wherein the third display panel and the first display panel are orthogonal.

In one example, the fireplace unit further includes a spatial separation spanning between the housing and the first visual display panel, between the housing and the second visual display panel, and between the housing and the third visual display panel. In one example, the blower vent includes one or more openings to allow convective heat transport for temperature distribution.

In one example, the fireplace unit further includes at least one polarized glass placed adjacent to at least one of first, second or third visual display panels. In one example, the fireplace unit further includes a first polarized glass placed adjacent to the first visual display panel, a second polarized glass placed adjacent to the second visual display panel, and a third polarized glass placed adjacent to the third visual display panel.

In one example, the first visual display panel is a light emitting diode (LED) display screen. In one example, the first visual display panel is a liquid crystal display (LCD) screen. In one example, the heating unit is an electric fan-forced heater or an electric infrared heater. In one example, the floor panel is a visual display panel.

In one example, the first visual display panel, the second visual display panel and the third visual display panel are each independently switchable to display one of the following: a static image, a dynamic image or a video. In one example, the first visual display panel, the second visual display panel and the third visual display panel are switchable to display one of the following: a static image, a dynamic image or a video.

In one example, the first visual display panel is a curved shape. In one example, the first visual display panel is a concave shape. In one example, the fireplace unit further includes a concave shaped polarized glass positioned adjacent to the first visual display panel. In one example, the fireplace unit further includes a floor panel which is a visual display panel in a curved shape that matches the concave shape of the first visual display panel, wherein the floor panel includes a reflective glass. In one example, the fireplace unit further includes a fan module located within the housing.

In one example, the disclosure discloses a fireplace unit including: a housing including a blower vent, a floor panel and an electrical housing area; a first visual display panel, a second visual display panel and a third visual display within the housing, wherein the first visual display panel, the second visual display panel and the third visual display panel are configured to display a static image, a dynamic image or a video; a heating unit configured to provide a heating source for the fireplace unit; and a power supply coupled to the heating unit, the first visual display panel, the second visual display panel and the third visual display panel, the power supply configured to supply electrical energy to the heating unit, the first visual display panel, the second visual display panel and the third visual display panel.

In one example, the housing is of a rectangular shape with a back side, a right side parallel to a left side, a top side parallel to a bottom side and wherein the second visual display panel is parallel to the right side, and the third visual display panel is parallel to the left side, and wherein the first visual display panel is curved.

In one aspect, one or more of the steps for providing the functionality of an electronic fireplace unit may be executed by one or more processors which may include hardware, software, firmware, etc. The one or more processors, for example, may be used to execute software or firmware needed to perform the steps to operate an electronic fireplace unit. Software shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise.

The software may reside on a computer-readable medium. The computer-readable medium may be a non-transitory computer-readable medium. A non-transitory computer-readable medium includes, by way of example, a magnetic storage device (e.g., hard disk, floppy disk, magnetic strip), an optical disk (e.g., a compact disc (CD) or a digital versatile disc (DVD)), a smart card, a flash memory device (e.g., a card, a stick, or a key drive), a random access memory (RAM), a read only memory (ROM), a programmable ROM (PROM), an erasable PROM (EPROM), an electrically erasable PROM (EEPROM), a register, a removable disk, and any other suitable medium for storing software and/or instructions that may be accessed and read by a computer. The computer-readable medium may also include, by way of example, a carrier wave, a transmission line, and any other suitable medium for transmitting software and/or instructions that may be accessed and read by a computer. The computer-readable medium may reside in a processing system, external to the processing system, or distributed across multiple entities including the processing system. The computer-readable medium may be embodied in a computer program product. By way of example, a computer program product may include a computer-readable medium in packaging materials. The computer-readable medium may include software or firmware. Those skilled in the art will recognize how best to implement the described functionality presented throughout this disclosure depending on the particular application and the overall design constraints imposed on the overall system.

Any circuitry included in the processor(s) is merely provided as an example, and other means for carrying out the described functions may be included within various aspects of the present disclosure, including but not limited to the instructions stored in the computer-readable medium, or any other suitable apparatus or means described herein, and utilizing, for example, the processes and/or algorithms described herein in relation to the example flow diagram.

Within the present disclosure, the word “exemplary” is used to mean “serving as an example, instance, or illustration.” Any implementation or aspect described herein as “exemplary” is not necessarily to be construed as preferred or advantageous over other aspects of the disclosure. Likewise, the term “aspects” does not require that all aspects of the disclosure include the discussed feature, advantage or mode of operation. The term “coupled” is used herein to refer to the direct or indirect coupling between two objects. For example, if object A physically touches object B, and object B touches object C, then objects A and C may still be considered coupled to one another—even if they do not directly physically touch each other. The terms “circuit” and “circuitry” are used broadly, and intended to include both hardware implementations of electrical devices and conductors that, when connected and configured, enable the performance of the functions described in the present disclosure, without limitation as to the type of electronic circuits, as well as software implementations of information and instructions that, when executed by a processor, enable the performance of the functions described in the present disclosure.

One or more of the components, steps, features and/or functions illustrated herein may be rearranged and/or combined into a single component, step, feature or function or embodied in several components, steps, or functions. Additional elements, components, steps, and/or functions may also be added without departing from novel features disclosed herein. The apparatus, devices, and/or components illustrated in the figures may be configured to perform one or more of the methods, features, or steps described herein. The novel algorithms described herein may also be efficiently implemented in software and/or embedded in hardware.

It is to be understood that the specific order or hierarchy of steps in the methods disclosed is an illustration of exemplary processes. Based upon design preferences, it is understood that the specific order or hierarchy of steps in the methods may be rearranged. The accompanying method claims present elements of the various steps in a sample order, and are not meant to be limited to the specific order or hierarchy presented unless specifically recited therein.

The previous description is provided to enable any person skilled in the art to practice the various aspects described herein. Various modifications to these aspects will be readily apparent to those skilled in the art, and the principles defined herein may be applied to other aspects. Thus, the claims are not intended to be limited to the aspects shown herein, but are to be accorded the full scope consistent with the language of the claims, wherein reference to an element in the singular is not intended to mean “one and only one” unless specifically so stated, but rather “one or more.” Unless specifically stated otherwise, the term “some” refers to one or more. A phrase referring to “at least one of” a list of items refers to any combination of those items, including single members. As an example, “at least one of: a, b, or c” is intended to cover: a; b; c; a and b; a and c; b and c; and a, b and c. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112, sixth paragraph, unless the element is expressly recited using the phrase “means for” or, in the case of a method claim, the element is recited using the phrase “step for.”

One skilled in the art would understand that various features of different embodiments may be combined or modified and still be within the spirit and scope of the present disclosure.

What is claimed is:

1. A fireplace unit comprising:
a housing including a blower vent, a floor panel and an electrical housing area;
a first visual display panel within the housing, the first visual display panel configured to display a static image, a dynamic image or a video;
a heating unit configured to provide a heating source for the fireplace unit;
a power supply coupled to the heating unit and the at least one visual display panel, the power supply configured to supply electrical energy to the heating unit and the at least one visual display panel.

2. The fireplace unit of claim 1, wherein the housing is of a rectangular shape with a back side, a right side parallel to a left side, a top side parallel to a bottom side; and
wherein the first visual display panel is parallel to the back side.

3. The fireplace unit of claim 2, further comprising a second display panel parallel to the right side and a third display panel parallel to the left side; and
wherein the second display panel and the first display panel are orthogonal; and
wherein the third display panel and the first display panel are orthogonal.

4. The fireplace unit of claim 3, further comprising a spatial separation spanning between the housing and the first visual display panel, between the housing and the second visual display panel, and between the housing and the third visual display panel.

5. The fireplace unit of claim 4, wherein the blower vent includes one or more openings to allow convective heat transport for temperature distribution.

6. The fireplace unit of claim 3, further comprising at least one polarized glass placed adjacent to at least one of first, second or third visual display panels.

7. The fireplace unit of claim 3, further comprising a first polarized glass placed adjacent to the first visual display panel, a second polarized glass placed adjacent to the second visual display panel, and a third polarized glass placed adjacent to the third visual display panel.

8. The fireplace unit of claim 1, wherein the first visual display panel is a light emitting diode (LED) display screen.

9. The fireplace unit of claim 1, wherein the first visual display panel is a liquid crystal display (LCD) screen.

10. The fireplace unit of claim 1, wherein the heating unit is an electric fan-forced heater or an electric infrared heater.

11. The fireplace unit of claim 1, wherein the floor panel is a visual display panel.

12. The fireplace unit of claim 3, wherein the first visual display panel, the second visual display panel and the third visual display panel are each independently switchable to display one of the following: a static image, a dynamic image or a video.

13. The fireplace unit of claim 3, wherein the first visual display panel, the second visual display panel and the third visual display panel are switchable to display one of the following: a static image, a dynamic image or a video.

14. The fireplace unit of claim 1, wherein the first visual display panel is a curved shape.

15. The fireplace unit of claim 1, wherein the first visual display panel is a concave shape.

16. The fireplace unit of claim 15, further comprising a concave shaped polarized glass positioned adjacent to the first visual display panel.

17. The fireplace unit of claim 16, further comprising a floor panel which is a visual display panel in a curved shape that matches the concave shape of the first visual display panel, wherein the floor panel includes a reflective glass.

18. The fireplace unit of claim 16, further comprising a fan module located within the housing.

19. A fireplace unit comprising:
a housing including a blower vent, a floor panel and an electrical housing area;
a first visual display panel, a second visual display panel and a third visual display within the housing, wherein the first visual display panel, the second visual display panel and the third visual display panel are configured to display a static image, a dynamic image or a video;
a heating unit configured to provide a heating source for the fireplace unit; and
a power supply coupled to the heating unit, the first visual display panel, the second visual display panel and the third visual display panel, the power supply configured to supply electrical energy to the heating unit, the first visual display panel, the second visual display panel and the third visual display panel.

20. The fireplace unit of claim 1, wherein the housing is of a rectangular shape with a back side, a right side parallel to a left side, a top side parallel to a bottom side and wherein the second visual display panel is parallel to the right side, and the third visual display panel is parallel to the left side, and wherein the first visual display panel is curved.
